(19) United States
(12) Patent Application Publication
(10) Pub. No.: US 2015/0227289 A1
(43) Pub. Date: Aug. 13, 2015

(54) PROVIDING A CALLOUT BASED ON A DETECTED ORIENTATION

(71) Applicants: Wes A. Nagara, Commerce Township, MI (US); Royce D. Channey, Ann Arbor, MI (US); Michael D. Tschirhart, Ann Arbor, MI (US)

(72) Inventors: Wes A. Nagara, Commerce Township, MI (US); Royce D. Channey, Ann Arbor, MI (US); Michael D. Tschirhart, Ann Arbor, MI (US)

(21) Appl. No.: 14/179,081

(22) Filed: Feb. 12, 2014

(51) Int. Cl. G06F 3/0484; G06F 3/041; G06F 3/0488

(52) U.S. Cl. CPC G06F 3/04842; G06F 3/04883; G06F 3/0412; G06F 3/0416

(57) ABSTRACT

A system and method for providing a callout based on a detected orientation is illustrated. The system includes a touch detector to detect an input to an interface; a callout detector to detect whether a callout is associated with the input; an orientation detector to determine a direction of the input; and a callout display driver to indicate a position of the callout based on the determined direction.

### BACKGROUND

In various input areas, interfaces are commonly become touchable. A touchable interface employs a touch surface or touch display (for example, capacitive or resistive touching), and reacts to a touch on a predefined portion of the surface or the display. In response to the touch, an electrical system is configured to perform a command based on the coordinate of the touch.

One such environment in which touch displays are becoming more common is vehicles. Touch screens provide an aesthetically pleasing experience, while being capable of providing a multitude of control options. Thus, a single interface may be employed to control temperature, audio, lighting, and the like. Accordingly, an implementer of a touch display system may conserve valuable real estate in the dashboard or cockpit area.

In situations where a touch display is employed, graphical user interface (GUI) elements provide an indication to an operator on the actions associated with the touch of a specific location. The GUI element may be any sort of digital indication, such as a static icon, a moving icon (i.e. mosaic icon), text, or combinations thereof.

In certain cases, the GUI element may initiate an opening of a secondary screen. The secondary screen may contain action items that are touchable as well. In certain cases, the display size may be limited, and thus, the secondary actions may be hidden until a parent GUI element is activated. The justification for an implementation such as the above is that the screen may not be capable of displaying every secondary action. Accordingly, a secondary action (or menu of action items) may only be displayed when requested.

### SUMMARY

A system and method for providing a callout based on a detected orientation is illustrated. The system includes a touch detector to detect an input to an interface; a callout detector to detect whether a callout is associated with the input; an orientation detector to determine a direction of the input, and a callout display driver to indicate a position of the callout based on the determined direction.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a block diagram illustrating an example computer.

FIG. 2 illustrates a system for providing a callout based on a detected orientation of an operator's interaction with a touch display.

FIG. 3 illustrates examples of the orientation detector of FIG. 2.

FIG. 4 illustrates a method for providing a callout based on a detected orientation of an operator's interaction with a touch display.

FIGS. 5(a) and 5(b) illustrate an example of the system of FIG. 2 being implemented.

### DETAILED DESCRIPTION

Detailed examples of the present disclosure are provided herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure.

An interface may be provided via a touch display. As explained in the background section, the interface serves as conduit between an operator and a system (for example, a vehicular control system). In response to an operator interacting with the interface, an electrical signal is transmitted to the vehicular control system. The vehicular control system may adjust the display of the touch display, accordingly.

A touch display may present information in a hierarchical manner. For example, a primary level of GUI elements may be presented, and when each of the primary level of GUI elements is interacted with, a secondary level of GUI elements may be presented. In this way, a singular touch display may be employed to present multiple menu items and system controls to an operator.

When one of the GUI elements is interacted with, a “callout” may be presented accordingly. The callout is essentially a secondary GUI element with additional action items. For example, if an operator initiates a GUI element for one of the items associated with the primary level, a secondary level (i.e. a menu, list, or additional GUI elements) may be presented.

In the field of touch screen displays, a finger or pointing apparatus may be employed to initiate contact with the GUI element. In response to the finger touching the display, the callout screen may be presented. Accordingly, the finger may block the callout screen, thus causing the operator to be annoyed and the user-experience to be lessened.

Disclosed herein are systems and methods for providing a callout based on a detected orientation. Accordingly, because the system and methods disclosed herein detect where an operator is relative to a GUI element, the callout screen may be provided in a non-hindered location of the touch screen display. In this way, the user-experience may be optimized and critical information association with the operation of an electronic system is presented in a more efficient manner. In systems where safety is paramount, such a vehicular control system, and an operator may spend less time interacting with the interface, and thus, experience a safer driving experience.

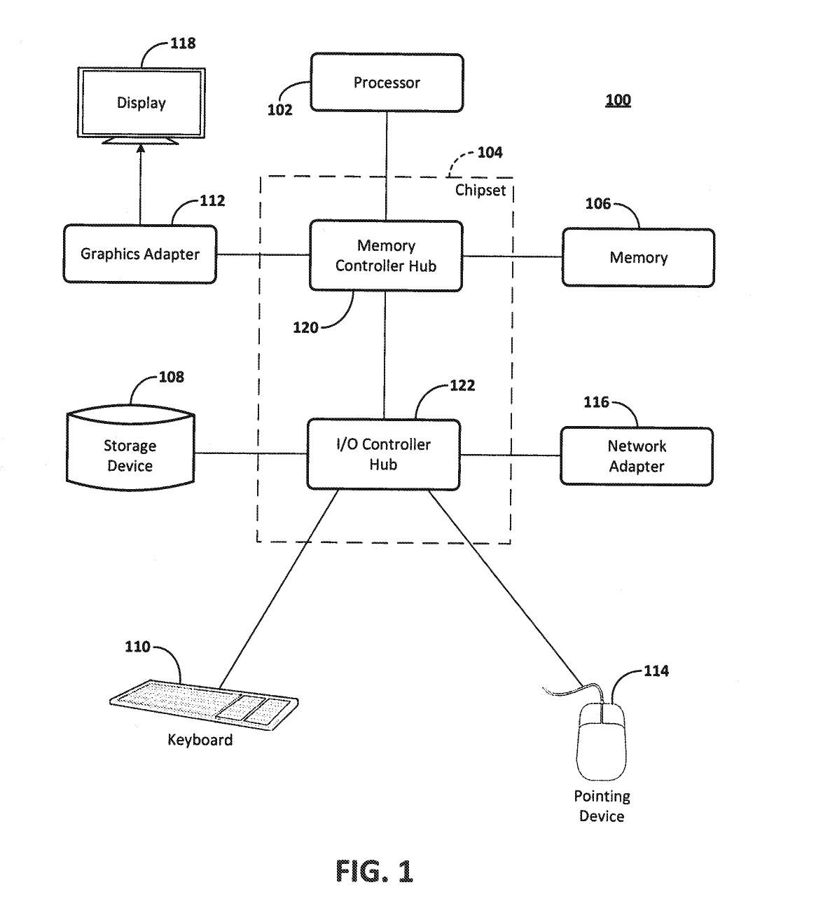

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer system 100. The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a video corpus, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

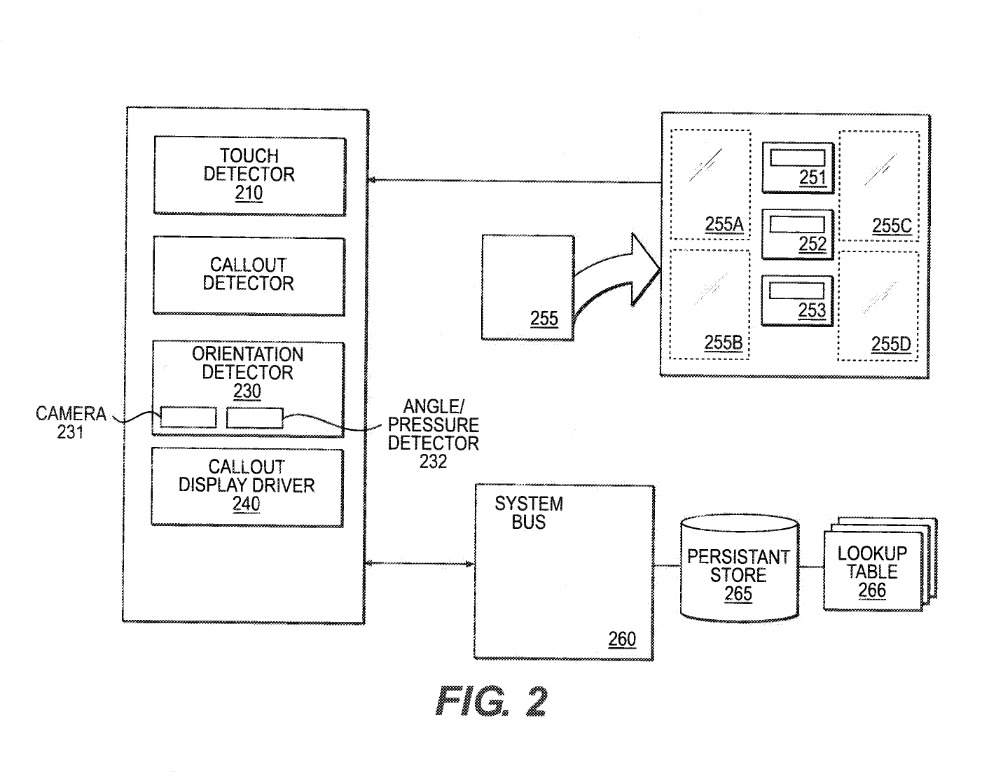

FIG. 2 illustrates a system 200 for providing a callout 255 based on a detected orientation of an operator's interaction with a touch display 250. The system 200 is coupled with a touch display 250. The touch display 250 may be any sort of touch receiving device, such as a touch surface or touch screen. The system 200 may be implemented via a processor, such as computer 100.

The touch display 250 may interact with a system bus 260. The system 200 may also interact with the system bus 260. The system bus 260 may control various devices and electronic systems. Based on an operator's interaction with the touch display 250, a feedback signal received from the system bus 260 may interact with the touch display 250, thereby modifying the presentation of information on the touch display 250. An operator may dynamically interact with the touch display 250, with various presentation screens being presented responsive to the operator's interaction.

Referring to FIG. 2, the touch display presently serves three GUI elements (251, 252, and 253). In response to one of the GUI elements being interacted with, a callout 255 GUI element is presented. The callout 255 may be presented in a various display areas of the touch display, such as display areas 254a, b, c, or d. The touch display 255 shows the GUI elements 251, 252, and 253 in the center of the touch display 250. The placement of the GUI elements shown in FIG. 2 is merely exemplary.

The touch detector 210 detects that a touch associated with touch display 250. For example, an operator may touch any of GUI elements 251-253, thereby initiating the system bus associated with the touch display 250 to perform an action. The touch detector 210 may detect which GUI element is touched. Alternatively, the touch detector 210 may be configured to not be cognizant of which element is activated.

The callout detector 220 determines whether a callout is associated with the detected touch, via touch detector 210. The system bus 260 may communicate with a data storage, such as persistent store 265, and record instructions associated with the GUI elements, such as GUI elements 251-253. The persistent store 265 may maintain a lookup table 266, with indications of whether each of the GUI elements is associated with a callout. Additionally, the lookup table 266 may also maintain information associated with the callouts size, and the menu items or additional GUI elements associated with the callout.

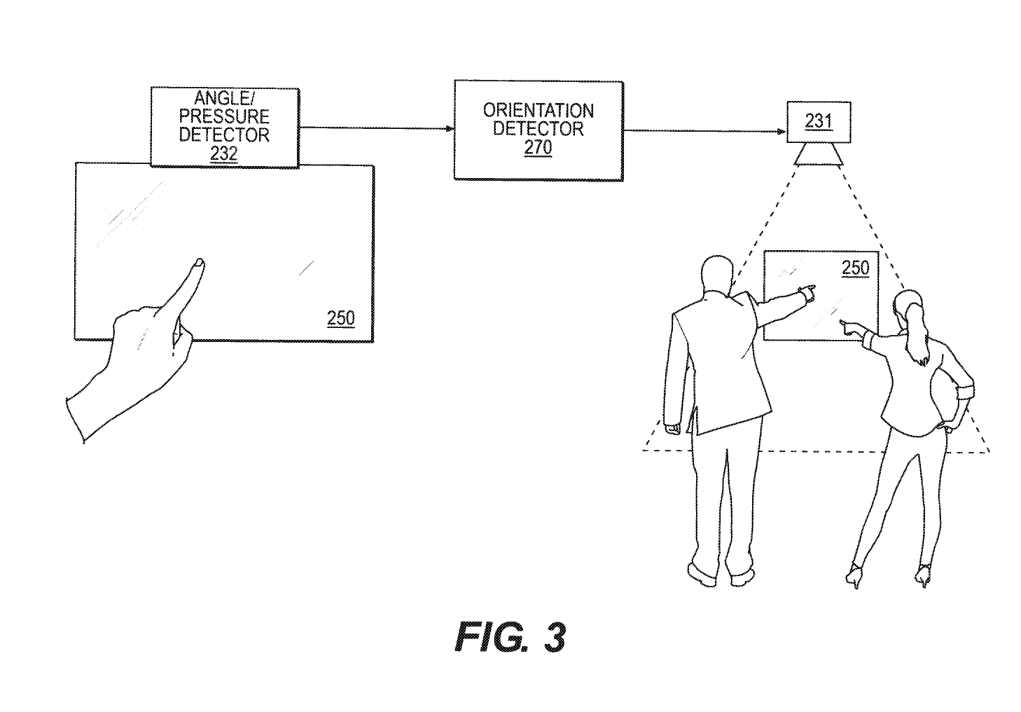

The orientation detector 230 detects the direction of approach associated with the touch. The orientation detector 230 may accomplish the determination through various techniques, which will be described further in regards to FIG. 3. In performing the orientation detection, the orientation detector ascertains the approximate location of an operator associated with the touch display 250.

The orientation detector 230 may employ eye tracking or head tracking to further control the GUI elements or to determine orientation. Alternatively, capacitive sensing technology may be implemented to further determine the orientation.

The callout display driver 240 transmits to the system bus 260 location information associated with the display of the callout 255. The location of the callout 255 may be determined in a location opposite the operator the touch display 250. For example, if the operator of the touch device is seated to the left of the touch display 250, the callout display driver 240 may transmit an indication to display the callout 255 to a portion of the screen to the right of the GUI element. In this way, a finger, hand or pointing apparatus may not effectively block a presentation of information associated with the callout 255. The system bus 260 may transmit the indication to the touch display 250.

The callout may be provided with an incremental GUI element. The incremental GUI element allows for step based settings of various control items. For example, the callout may have various icons indicating various settings. Every time one of the icons is either asserted or de-asserted, the setting of the associated control may be adjusted accordingly.

FIG. 3 illustrates examples of alternate implementations of the orientation detector 230. An implementer of system 200 may determine to implement some or all of the enumerated techniques. In addition to those implementations described in FIG. 3, one of ordinary skill in the art may implement other techniques to detect the orientation or position of the operator of the touch display 250.

In one example, the orientation detector 230 may be implemented with a camera 231. The camera 231 captures an image or video of the operator approaching the touch display 250. Based on the captured image, the orientation detector 230 may ascertain where the operator is relative to the touch display 250. The camera 231 may be installed in a system for another purpose, such as aiding a vehicle or an electronic system perform gaze tracking.

In another example, the orientation detector 230 may be equipped and configured with an angle/pressure detector 232. By employing the angle/pressure detector 232, the touch display 250 is capable of detecting the angle and approach of a touch to the touch display 250. Accordingly, by detecting the angle/pressure associated with a touch, the orientation detector 230 may determine the direction of the touch.

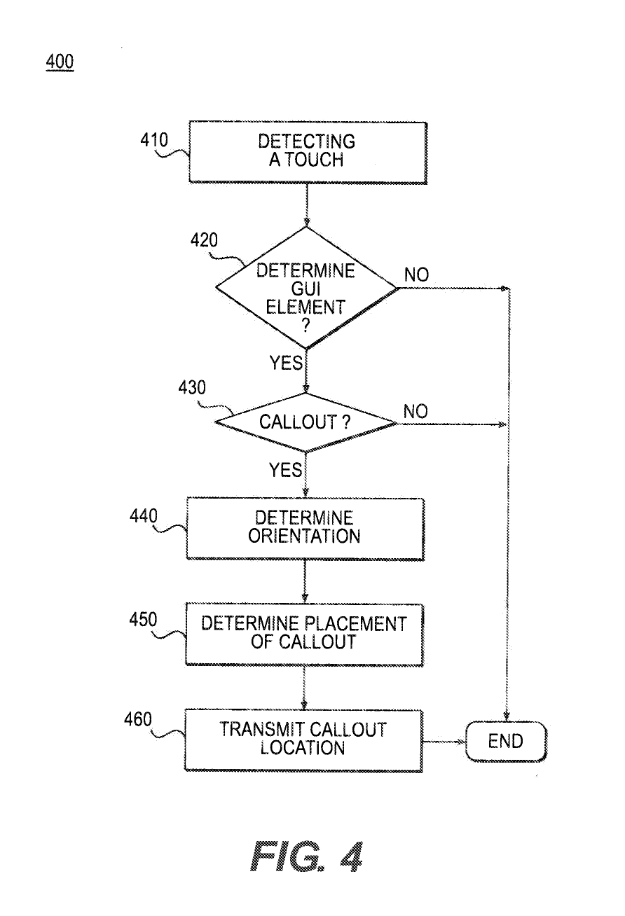

FIG. 4 illustrates an example of a method 400 providing a callout based on a detected orientation of an operator's interaction with a touch display. The method 400 may be implemented with a system, such as system 200 described above.

In operation 410, a touch to a touch display is detected. As explained above, the touch display may be implemented along with various electronic systems, such as a touch display in a vehicle.

In operation 420, a determination is made as to which GUI element the touch is associated with. Once the GUI element is ascertained, the method 400 may cross-reference a database to determine whether the GUI element is associated with a callout (operation 430).

In operation 440, if the GUI element is associated with a callout, an orientation of the operator associated with the touch is determined. As explained above in regards to FIG. 3, various techniques illustrated and those known to one of ordinary skill in the art may be employed to accomplish operation 440.

In operation 450, based on the determined orientation, a placement of the callout is determined. The placement of the callout may be in a portion of the display not blocked by an object, such as the operator's hand. Accordingly, the callout may be visible and easy to access.

In operation 460, the callout location is transmitted to the touch display or a system or processor associated with driving the control of the touch display.

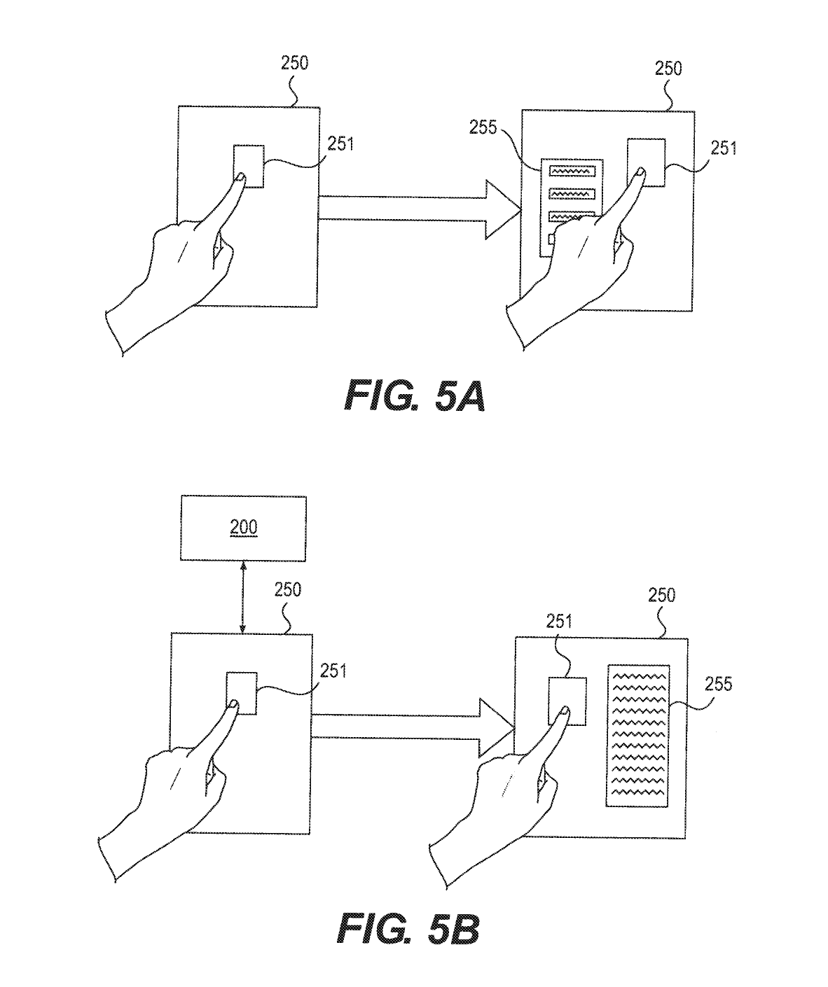

FIGS. 5(a) and (b) illustrate an example of system 200 not being implemented, and an example of system 200 being implemented. The touch display 250 shown in FIGS. 5(a) and 5(b) may be implemented, for example, in a vehicle.

Referring to FIG. 5(a), a GUI element 251 is touched. Accordingly, as shown, a callout 255 is displayed. The callout may be an actionable menu in which the operator may engage with. As shown in FIG. 5(a), without an implementation of system 200, the operator's hand obscures the callout 255.

Referring to FIG. 5(b), the touch display 250 operates in conjunction with system 200. Accordingly, as shown GUI element 251 is touched, and the touch instigates a display of callout 255.

As shown, and contrary to the example shown in FIG. 5(a), the callout 255 is displayed in a region of the touch display 255 not obscured by an operator's hand. Accordingly, employing the systems and methods disclosed herein, an enhanced user experience is provided to an operator of a touch display 250. Further, because potentially critical information is not obscured (for example, as shown above, with an operator's hand), an operator of a touch display 255 may realize a safer experience. In applications such as a vehicle, the safer experience afforded may allow the driver of the vehicle to operate the vehicle in a safer way.

While examples of the disclosure have been illustrated and described, it is not intended that these examples illustrate and describe all possible forms of the disclosure. Rather, the words used in the specification are words of description rather than limitation, and it is understand that various changes may be made without departing from the spirit and scope of the disclosure. Additionally, the features and various implementing embodiments may be combined to form further examples of the disclosure.

We claim:

1. A system for providing a callout based on a detected orientation, comprising:
a data store comprising a computer readable medium storing a program of instructions for the providing of the callout;
a processor that executes the program of instructions;
a touch detector to detect an input to an interface;
a callout detector to detect whether a callout is associated with the input;
an orientation detector to determine a direction of the input; and
a callout display driver to indicate a position of the callout based on the determined direction.

2. The system according to claim 1, wherein the input is defined as a graphical user interface (GUI) element of a touch display.

3. The system according to claim 2, wherein the callout is a secondary GUI element associated with the input, and the position is a portion of the touch display.

4. The system according to claim 1, wherein the portion of the touch display is on a side opposite the determined direction of the input.

5. The system according to claim 1, wherein the orientation detector is coupled to an image/video capturing device to monitor a user associated with the input.

6. The system according to claim 1, wherein the orientation detector is a coupled to an angle/pressure sensor.

7. The system according to claim 2, wherein the touch display is installed in a vehicle.

8. A method performed on a processor for providing a callout based on a detected orientation, comprising:
detecting an input to an interface;
detecting whether a callout is associated with the input;
determining a direction of the input; and
indicating a position of the callout based on the determined direction,
wherein at least one of the detecting, determining, or indicating is performed on a processor.

9. The method according to claim 8, wherein the input is defined as a graphical user interface (GUI) element of a touch display.

10. The method according to claim 9, wherein the callout is a secondary GUI element associated with the input, and the position is a portion of the touch display.

11. The system according to claim 8, wherein the portion of the touch display is on a side opposite the determined direction of the input.

12. The method according to claim 8, wherein the orientation detector is coupled to an image/video capturing device to monitor a user associated with the input.

13. The method according to claim 8, wherein the orientation detector is a coupled to an angle/pressure sensor.

14. The method according to claim 9, wherein the touch display is installed in a vehicle.

15. A touch display device, comprising:
a first graphical user interface (GUI) element;
a callout associated with the first GUI element;
wherein in response to the first GUI element being initiated by a user's touch, the callout being displayed on the touch display device based on a position of the user's touch.
